(19) United States
(12) Patent Application Publication
(10) Pub. No.: US 2007/0222389 A1
(43) Pub. Date: Sep. 27, 2007

(54) Low Pressure Discharge Lamp Comprising a Discharge Maintaining Compound

(75) Inventor: Rainer Hilbig, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,252

(22) PCT Filed: May 17, 2005
(86) PCT No.: PCT/IB05/51602

§ 371 Date: Nov. 17, 2006

(30) Foreign Application Priority Data
May 27, 2004 (EP) 04102336.7

(51) Int. Cl. H01J 61/18

(52) U.S. Cl. 313/638

(57) ABSTRACT

The invention is concerned with a low-pressure gas discharge lamp provided with a gas discharge vessel containing a gas filling with an zinc compound and a buffer gas, which low-pressure gas discharge lamp is also provided with electrodes and means for generating and maintaining a low-pressure gas discharge.

The invention relates to a low-pressure gas discharge lamp comprising a gas discharge vessel containing a gas filling with a discharge maintaining compound, inner or outer electrodes or being electrodeless and having means for generating and maintaining a low-pressure gas discharge.

Light generation in low-pressure gas discharge lamps is based on the principle of charge carriers, particularly electrons but also ions, being accelerated so strongly by an electric field between the electrodes of the lamp that collisions with the gas atoms or molecules in the gas filling of the lamp cause these gas atoms or molecules to be excited or ionized. When the atoms or molecules of the gas filling return to the ground state, a more or less substantial part of the excitation energy is converted to radiation.

Conventional low-pressure gas discharge lamps comprise mercury in the gas filling and, in addition, a phosphor coating on the inside of the gas discharge vessel. A drawback of the mercury low-pressure gas discharge lamps resides in the fact that mercury vapor primarily emits radiation in the high-energy, yet invisible UV-C range of the electromagnetic spectrum, which radiation must first be converted by the phosphors to visible radiation with a much lower energy level. In this process, the energy difference is converted to undesirable thermal radiation.

In addition, the mercury in the gas filling is ever more regarded as an environmentally harmful and toxic substance that should be avoided as much as possible in present-day mass-products as its use, production and disposal pose a threat to the environment.

It is known already that the spectrum of low-pressure gas discharge lamps can be influenced by substituting the mercury in the gas filling with other substances.

For example, US2002047525 discloses a low-pressure gas discharge lamp provided with a gas discharge vessel containing a gas filling with an indium compound as the UV emitter and a buffer gas, which low-pressure gas discharge lamp is also provided with electrodes and means for generating and maintaining a low-pressure gas discharge. This indium-containing low-pressure gas discharge lamp emits in the visible range as well as in the UV range.

It is an object of the invention to provide a low-pressure gas discharge lamp the radiation of which is closest possible to the visible region of the electromagnetic spectrum and which has improved efficiency and radiation intensity.

In accordance with the invention, this object is achieved by a low-pressure gas discharge lamp comprising a gas discharge vessel, which contains a gas filling with a zinc compound and a buffer gas, which low-pressure gas discharge lamp also comprises inner or outer electrodes or is electrodeless and has means for generating and maintaining a low-pressure gas discharge.

In the lamp in accordance with the invention, a molecular gas discharge takes place at a low pressure. Such gas discharge emits some broadband radiation in the visible range but mainly in the UV- range of the electromagnetic spectrum together with the characteristic lines of atomic zinc.

In combination with phosphors, the lamp in accordance with the invention has a visual efficiency which is substantially higher than that of conventional low-pressure mercury discharge lamps. The visual efficiency, expressed in lumen/Watt, is the ratio of the brightness of the radiation in a specific visible wavelength range to the energy for generating the radiation. The high visual efficiency of the lamp in accordance with the invention means that a specific quantity of light is obtained at lower power consumption. Besides, the use of mercury is avoided.

As an UV lamp, the lamp in accordance with the invention is advantageously used as a disinfecting lamp or a lacquer-curing lamp. For general illumination purposes, the lamp is combined with appropriate phosphors. As the losses caused by Stokes' displacement are small, visible light having a high luminous efficiency above 100 lumens/Watts is obtained.

Within the scope of the invention it may be preferred that the zinc compound is selected from the group formed by the halides, oxides, chalcogenides, hydroxides and metal-organic compounds of zinc.

A gas filling with zinc halides is particularly preferred.

The use of a gas filling containing a mixture of more than one zinc halide is also of advantage.

It may be alternatively preferred for the gas filling to comprise, as a further additive, elemental zinc. For the buffer gas, the gas filling may comprise an inert gas selected from the group formed by helium, neon, argon, krypton and xenon. Advantageously, the gas pressure of the inert gas at the operating temperature ranges from 0.1 mbar to 100 mbar, with 2 mbar being the preferred value.

Within the scope of the invention it may be preferred that the gas discharge vessel comprises a phosphor coating on the inside or outside surface of the wall. These and other aspects of the invention will be apparent from and elucidated with reference to a drawing and 1 embodiment.

### DETAILED DESCRIPTION

In the embodiment shown in FIG. 1, the low-pressure gas discharge lamp in accordance with the invention is composed of a tubular lamp bulb 1, which surrounds a discharge space. At both ends of the tube, inner electrodes 2 are sealed in, via which electrodes the gas discharge can be ignited. The low-pressure gas discharge lamp comprises a lamp holder and a lamp cap 3. An electrical ballast is integrated in known manner in the lamp holder or in the lamp cap, which ballast is used to control the ignition and the operation of the gas discharge lamp. In a further embodiment, not shown in FIG. 1, the low- pressure gas discharge lamp can alternatively be operated and controlled via an external ballast.

The gas discharge vessel may alternatively be embodied so as to be a multiple-bent or coiled tube surrounded by an outer bulb. For the gas filling use is made of, in the simplest case, a zinc halogenide in a quantity of 2×10⁻¹¹ /cm³ to 2×10⁻⁸ /cm³ and an inert gas. The inert gas serves as a buffer gas enabling the gas discharge to be more readily ignited. For the buffer gas preferably argon is used. Argon may be substituted, either completely or partly, with another inert gas, such as helium, neon, krypton or xenon.

The lumen efficiency can be improved by adding elemental zinc as an additive to the gas filling. The efficiency can also be improved by combining two or more zinc halides in the gas atmosphere.

The efficiency can be further improved by optimizing the internal pressure of the lamp during operation. The maximum cold filling pressure of the buffer gas is 100 mbar. Preferably, said pressure lies in a range between 1.5 and 2.5 mbar.

It has been found that, in accordance with a further advantageous measure, an increase of the lumen efficiency of the low- pressure gas discharge lamp can be achieved by controlling the operating temperature of the lamp by means of suitable constructional measures. The diameter and the length of the lamp are chosen to be such that, during operation at an outside temperature of 25° C., an inside temperature in the range from 195 to 335° C. is attained. This inside temperature relates to the coldest spot of the gas discharge vessel as the discharge brings about a temperature gradient in the vessel.

To increase the inside temperature, the gas discharge vessel may also be coated with an infrared radiation-reflecting coating. Preferably, use is made of an infrared radiation-reflecting coating of tin oxide.

In this case it was found that, in a low-pressure gas discharge lamp with a gas filling containing zinc chloride, the cold spot temperature should lie in the range from 235 to 335° C., preferably 285° C., at the operating temperature. Analogously, in the case of a gas filling containing zinc bromide, the cold spot temperature should lie in the range from approximately 230 to 330° C., preferably at approximately 280° C.

In the case of a gas filling containing zinc iodide, the cold spot temperature should lie in the range from approximately 195 to 295° C., preferably at approximately 245° C.

A combination of the three measures mentioned hereinabove also proved to be advantageous.

A suitable material for the electrodes in the low-pressure gas discharge lamp in accordance with the invention comprises, for example, nickel, a nickel alloy or a metal having a high melting point, in particular tungsten and tungsten alloys. Also composite materials of tungsten with thorium oxide or zinc oxide can suitably be used. Work function can be further reduced by emitter materials on the electrode.

In the embodiment in accordance with FIG. 1, the outside surface of the gas discharge vessel of the lamp is coated with a phosphor layer 4. The UV-radiation originating from the gas discharge excites the phosphors in the phosphor layer so as to emit light in the visible region 5.

The chemical composition of the phosphor layer determines the spectrum of the light or its tone. The materials that can suitably be used as phosphors must absorb the generated radiation and emit said radiation in a suitable wavelength range, for example for the three basic colors red, blue and green, and enable a high fluorescence quantum yield to be achieved.

Suitable phosphors and phosphor combinations need not necessarily be applied to the inside of the gas discharge vessel; they may alternatively be applied to the outside of the gas discharge vessel if suited transmittive wall materials like quartz glass are used.

In accordance with another embodiment, the lamp is capacitively excited using a high-frequency field, the electrodes being provided on the outside of the gas discharge vessel.

In accordance with a further embodiment, the lamp is inductively excited using a high-frequency field, e.g. 2.65 MHz, 13.56 MHz or 2.4 GHz. When the lamp is ignited, the electrons excite the atoms and molecules of the gas filling so as to emit the characteristic UV radiation and visible lines of atomic zinc.

The discharge heats up the gas filling such that the desired vapor pressure and the desired operating temperature ranging from 230° C. to 290° C. is achieved at which the light output is optimal.

The radiation from the zinc halogenide-containing gas filling generated during operation exhibits mainly the line spectrum of the elemental zinc at 214 nm and 308 nm

### EXAMPLE 1

A cylindrical discharge vessel of glass, which is transparent to UV radiation, having a length of 25 cm and a diameter of 2.5 cm is provided with outer electrodes of copper. The discharge vessel is evacuated and simultaneously a dose of 0.3 mg zinc chloride is added. Also argon is introduced at a cold pressure of 2.5 mbar. A high frequency field having a frequency of 13.5 MHz is supplied from an external source and the efficiency is measured at an operating temperature of 285° C. The plasma efficiency is above 50%.

### DRAWING DESCRIPTION

In the drawing:

FIG. 1 diagrammatically shows the light generation in a low- pressure gas discharge lamp comprising a gas filling containing a zinc (II) compound.

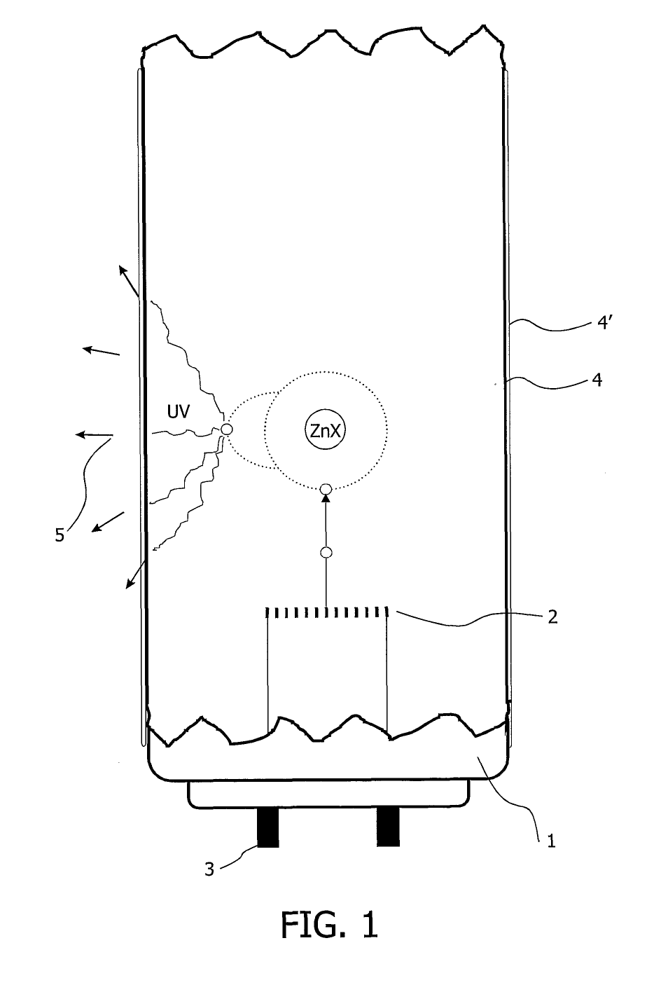

1. A low-pressure gas discharge lamp comprising a gas discharge vessel which contains a gas filling with a zinc compound and a buffer gas, which low-pressure gas discharge lamp also comprises inner or outer electrodes or is electrodeless and has means for generating and maintaining a low-pressure gas discharge.

2. A low-pressure gas discharge lamp as claimed in claim 1, characterized in that the zinc compound is selected from the group formed by halides, oxides, chalcogenides, hydroxides and the metal-organic compounds of zinc.

3. A low-pressure gas discharge lamp as claimed in claim 1, characterized in that the zinc compound is selected from the group formed by the halides.

4. A low-pressure gas discharge lamp as claimed in claim 1, characterized in that the gas filling comprises a mixture of more than one zinc halide.

5. A low-pressure gas discharge lamp as claimed in claim 1, characterized in that the gas filling comprises, as a further additive, elemental zinc.

6. A low-pressure gas discharge lamp as claimed in claim 1, characterized in that the gas filling comprises an inert gas, selected from the group formed by helium, neon, argon, krypton and xenon, as the buffer gas.

7. A low-pressure gas discharge lamp as claimed in claim 1, characterized in that the gas filling comprises an inert gas, selected from the group formed by helium, neon, argon, krypton and xenon, as the buffer gas, the gas pressure at the operating temperature ranging from 0.1 to 100 mbar.

8. A low-pressure gas discharge lamp as claimed in claim 1, characterized in that the gas filling comprises an inert gas, selected from the group formed by helium, neon, argon, krypton and xenon, as the buffer gas, the gas pressure at the operating temperature being 4 mbar.

9. A low-pressure gas discharge lamp as claimed in claim 1, characterized in that the gas discharge vessel comprises a phosphor coating applied to the inner or the outer surface.

10. A low-pressure gas discharge lamp as claimed in claim 1, characterized in that the gas discharge vessel comprises a heat reflective coating applied to the outer surface of the discharge tube or to the inner or outer surface of an outer bulb.
